(19) United States
(12) Patent Application Publication
(10) Pub. No.: US 2005/0108619 A1
(43) Pub. Date: May 19, 2005

(54) System and method for content management

(76) Inventors: James Danial Theall, Boulder, CO (US); Charles Raymond Mauldin, Longmont, CO (US)

Correspondence Address: Cooley Godward LLP;ATTN: Patent Group, One Freedom Square, Reston Town Center, 11951 Freedom Drive, Reston, VA, 20190-5656, US

(21) Appl. No.: 10/712,397

(22) Filed: Nov. 14, 2003

(51) Int. Cl. G06F 17/00

(52) U.S. Cl. 715/500

(57) ABSTRACT

Embodiments of the invention provide an administrative utility for associating keywords or other metadata, sequence information, and/or one or more elements of a story matrix with a presentation slide, document page, or other portion of a document. Embodiments of the invention provide a search utility for identifying and/or importing a presentation slide, document page, or other portion of a pre-existing document based on one or more of keyword(s) and/or other metadata. Embodiments of the invention provide a utility for ordering presentation slides, document pages, or other portions of documents based on one or more of sequence information and/or one or more story matrix elements. Embodiments of the invention provide a utility for identifying and/or correcting slide or page formatting errors that may be associated with the reuse of presentation slides, document pages, or other portions of documents in a new presentation or other document. Any one or combination of the foregoing features may advantageously improve the cost and/or cycle time associated with creating a new presentation or other document.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The invention relates to knowledge management. In particular, but not by way of limitation, the invention relates to a system and method for creating new presentations or other documents based, at least in part, on content found in existing documents.

### BACKGROUND OF THE INVENTION

As used herein, a content creator is a source of information, and a content consumer is a person who packages information for presentation. Various software tools exist to facilitate an author, editor, content creator or content consumer in the development of presentations or other documents for one or more target audiences. For example, Microsoft® PowerPoint aids the content creator in the development of multi-slide presentations, and a content creator might use Microsoft® Word to draft multi-page documents.

One problem is that, notwithstanding the use of software tools such as PowerPoint or Word, content creators may spend excessive time preparing presentations or other documents due to a lack of reuse of content from pre-existing presentations or other documents created by a content creator. Moreover, there may be ineffective means for communication between content creators and content consumers.

One known solution facilitates the reuse of content by identifying existing documents via the application of keyword searches. Another known solution identifies existing documents by first associating existing documents with one or more predefined categories, then allowing a user to identify one or more existing documents based on the one or more predefined categories.

These known systems and methods for facilitating content reuse have many disadvantages, however. For example, in many cases, it is appropriate for a content consumer to reuse only a portion of a pre-existing presentation or other document. In this instance, the identification and/or importation of an entire presentation or other document is a less than optimal solution. Moreover, known systems and methods for identifying content for reuse provide no guidance to the content consumer on how to order the identified pre-existing content in creating a new presentation or other document.

What is needed is a technique for improving the way that content consumers create new presentations or other documents. More specifically, a system and method is needed for identifying and managing relevant portions of presentations or other documents. In addition, a system and method is needed that will assist the content consumer in ordering the identified portions of pre-existing content to create a new presentation or other document.

### SUMMARY OF THE INVENTION

Embodiments of the invention provide an administrative utility for associating keywords or other metadata, sequence information, and/or one or more elements of a story matrix with a presentation slide, document page, or other portion of a document. Embodiments of the invention provide a search utility for identifying and/or importing a presentation slide, document page, or other portion of a pre-existing document based on one or more of keyword(s) and/or other metadata. Embodiments of the invention provide a utility for ordering presentation slides, document pages, or other portions of documents based on one or more of sequence information and/or one or more story matrix elements. Embodiments of the invention provide a utility for identifying and/or correcting slide or page formatting errors that may be associated with the reuse of presentation slides, document pages, or other portions of documents in a new presentation or other document. Any one or combination of the foregoing features may advantageously improve the cost and/or cycle time associated with creating a new presentation or other document.

As used herein, a presentation (or slide show, or show) is an electronic or printed series of slides. A slide is a portion of the presentation, typically, but not necessarily, a still frame of text and/or graphics. A slide may also contain audio files, video files, animations, or other media components.

Exemplary embodiments of the invention shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

### BRIEF DESCRIPTION OF THE DRAWINGS

Various objects, advantages, and a more complete understanding of the invention are apparent and more readily appreciated by reference to the following Detailed Description and to the appended claims when taken in conjunction with the accompanying Drawings wherein:

FIG. 1 is a block diagram of a functional architecture, according to an embodiment of the invention;

FIG. 2 is a process flow diagram of a collaboration process, according to an embodiment of the invention;

FIG. 3 is a process flow diagram of an administrative process, according to an embodiment of the invention;

FIG. 4 is an illustration of a graphical user interface used in selecting and importing shows, according to an embodiment of the invention;

FIG. 5 is an illustration of a graphical user interface used in associating one or more elements of a story matrix with a slide, according to an embodiment of the invention;

FIG. 6 is a process flow diagram of a show creation process, according to an embodiment of the invention;

FIG. 7 is an illustration of a graphical user interface used in a log-in process, according to an embodiment of the invention;

FIG. 8 is an illustration of a graphical user interface used in a story-builder process, according to an embodiment of the invention;

FIG. 9 is an illustration of a graphical user interface used in a searching process, according to an embodiment of the invention;

FIG. 10 is an illustration of a graphical user interface used in a reviewing process, according to an embodiment of the invention;

FIG. 11 is an illustration of a graphical user interface used in a formatting process, according to an embodiment of the invention;

FIG. 12 is a process flow diagram for formatting slides in a show, according to an embodiment of the invention;

FIG. 13 is a block diagram of a functional architecture for a content management system, according to an embodiment of the invention;

FIG. 14 is a block diagram of a functional architecture for a director/presentation client, according to an embodiment of the invention; and

FIG. 15 is a block diagram of a functional architecture for a document management server, according to an embodiment of the invention.

### DETAILED DESCRIPTION

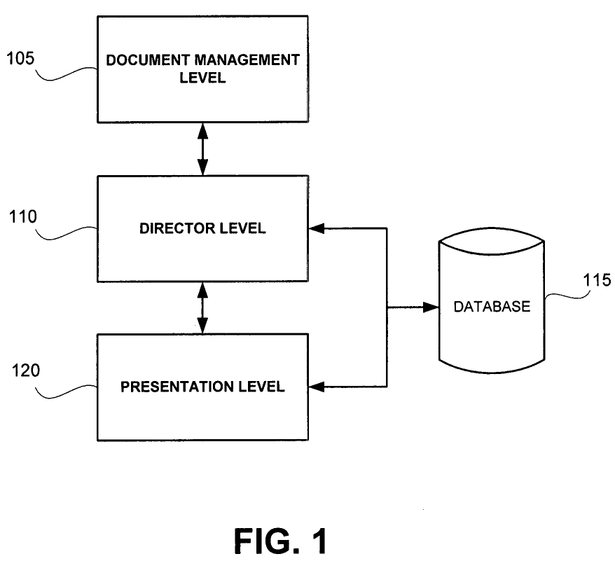

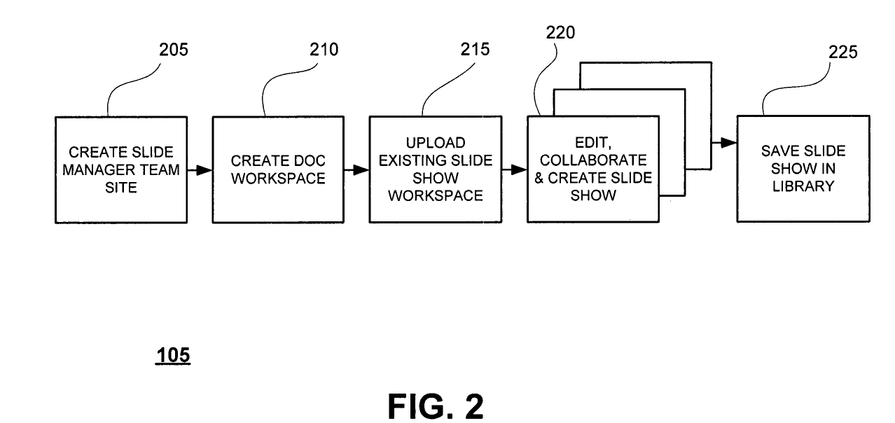

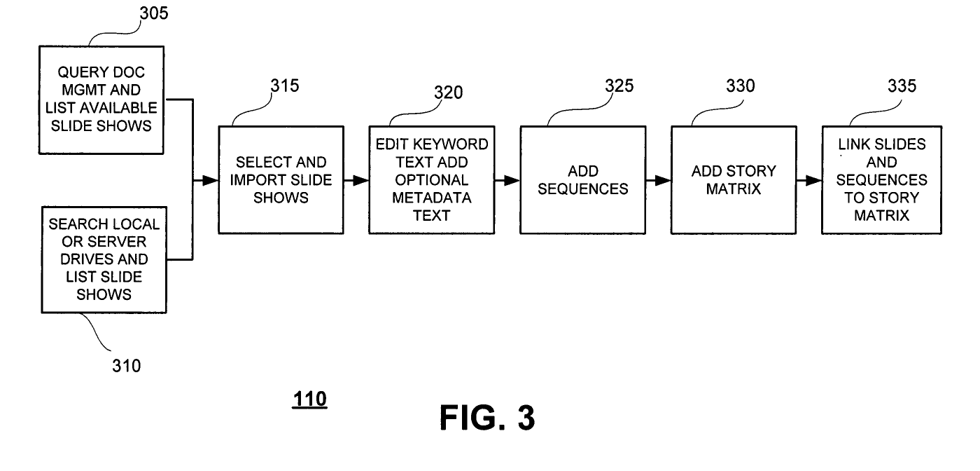

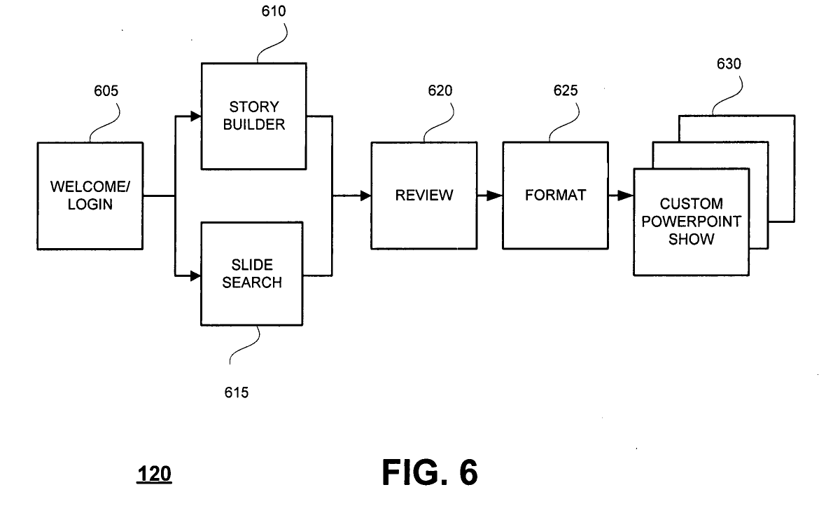

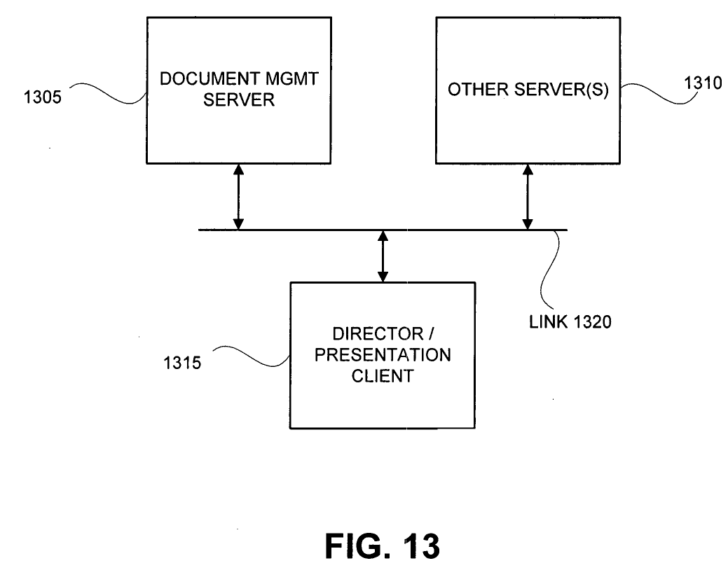

Embodiments of the invention facilitate content reuse during creation of a slide show. Embodiments of the invention are described first with respect to a high-level functional architecture in FIG. 1, and a document management process with reference to FIG. 2. Next, an administrative process is described with reference to FIGS. 3-5. Then, a process for creating a slide show is disclosed with reference to FIGS. 6-12. Finally, in FIGS. 13-15, a more detailed functional architecture is described, which can implement one or more of the foregoing management, administration, and creation processes.

While sub-headings are used in this section for organizational convenience, the disclosure of any particular feature(s) is/are not necessarily limited to any particular section or sub-section of this specification.

Functional Architecture Overview

FIG. 1 is a block diagram of a functional architecture, according to an embodiment of the invention. As shown therein, the functional architecture includes an document management level 105 coupled to a director level 110. The director level 110 is additionally coupled to a presentation level 120. The director level 110 and the presentation level 120 are each additionally coupled to database 115.

The document management level 105 provides a means for collaboration between content creators. In the director level 110, keywords, metadata, sequence information, and/or one or more story matrix elements is associated with individual slides, and the slides and associated data are stored in database 115. In presentation level 120, a content consumer may selectively identify and export slides from database 115 based on keyword or metadata search. Separately, or in combination, in presentation level 120, a content consumer may identify and order slides based on keyword, sequence data and/or story matrix elements. Slide formatting may be addressed in director level 110 and/or presentation level 120.

Not all levels of the functional architecture are required. For example, embodiments of the invention can operate absent the functionality of document management level 105.

Document Management Level

FIG. 2 is a process flow diagram of a collaboration process, according to an embodiment of the invention. The process illustrated in FIG. 2 may operate at document management level 105. As shown in FIG. 2, a collaborative process for publishing an approved presentation or other document begins in step 205 by creating a team Web site or other workspace. Then, in step 210, a document workspace is created. In step 215, a draft slide show is uploaded to the document workspace created in step 210. Next, in step 220, one or more content creators edit, collaborate and create a slide show or other document in step 220. Advantageously, one or more content creators may utilize functionality at director level 110 in performing editing step 220. Finally, at the completion of the collaborative effort illustrated in FIG. 2, a final slide show is saved in a library in step 225.

Some of the operations shown in FIG. 2 are optional. For example, document management level collaboration could exist without creating a team site in step 205. Moreover, publication of other action could replace saving step 225, according to application requirements.

Director Level

FIG. 3 is a process flow diagram of an administrative process, according to an embodiment of the invention. The process illustrated in FIG. 3 may be performed at the director level 110. The objective of the administrative process is to associate keywords, metadata, sequence information, and/or story matrix elements with individual slides.

In the illustrated embodiment, the process begins by querying a document management system for available slide shows in step 305, and/or by searching one or more local or server drives for available slide shows in step 310. In step 315, a user selects and imports one or more slide shows based on, for example, creation date, file name, or other criteria commonly associated with an electronic file. In step 320, a user edits keyword text, and optionally associates additional metadata text for one or more slides in each of one or more selected slide shows.

Then, in step 325, a user may associate one or more slides with a group of slides and a presentation sequence. For example, in step 325, a user may sequence each of three slides in a first group that present related information in a flow that moves from general content to more specific content (e.g., “1” is associated with the slide having the most general content, “2” is associated with the slide having the next most general content, and a “3” is associated with the slide having the most specific content). As another example, a user performing step 325 may associate a sequence with each slide of a second group, where the slides present related information in a historical chronology. Accordingly, any slide may be associated with group and sequence information.

Next, in step 330, a user may associate one or more story matrix elements to one or more slides. In one embodiment, the story matrix elements include a theme, act, and/or a scene, as understood in the usual playwright sense, and as will be described in more detail below. Finally, in step 335, individual slides are linked by saving associations with the sequence information added in step 325 and/or with story matrix elements added in step 330. Accordingly, the process illustrated in FIG. 3 associates information on a per slide basis. Preferably, linked slides are then stored in database 115 or elsewhere (step not shown).

Not all process steps illustrated in FIG. 3 are required. For example, steps 320, 325 and 330 may be used in the alternative, or in any combination. Moreover, the ordering of steps 320, 325 and 330 may be altered according to design choice. Further, in other embodiments, linking step 335 may be included in one or more of steps 320, 325 and 330.

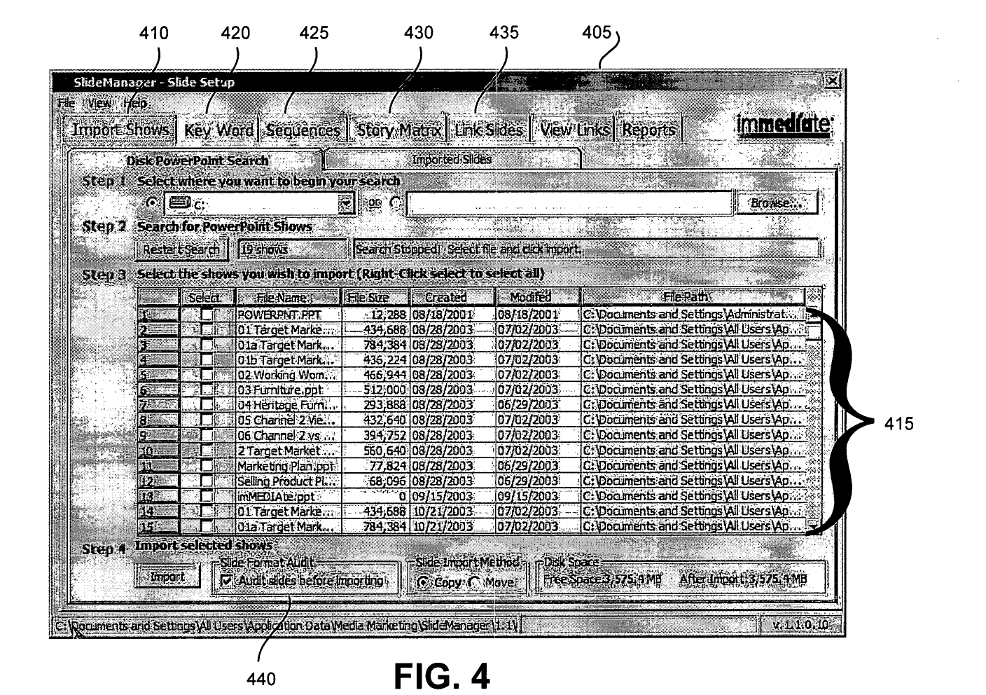

FIG. 4 is an illustration of a graphical user interface (GUI) used in selecting and importing shows, according to an embodiment of the invention. As shown in FIG. 4, a GUI 405 includes functional buttons 410, 420, 425, 430 and 435 related to process steps 315, 320, 325, 330, and 335, respectively. GUI 405 also includes slide show listing area 415, and slide format audit selection box 440.

The GUI in FIG. 4 is an exemplary interface for performing selection step 315. For example, an administrator or other user may select one or more slide shows by checking boxes in slide show listing area 415. In alternative embodiments, other selection means, for example clicking and dragging, may also be used, according to design choice. The effect of selecting slide format audit selection box 440 is that selected slides can be audited for format prior to importing. The types of formatting that can be audited include, for instance, vertical slide orientation (e.g., portrait v. landscape), color scheme, missing or blank titles, title font style, and title font size. Advantageously, identified formatting attributes can be automatically associated with each slide of an imported presentation, and/or an administrator or other user at the director level can be prompted to correct errors or otherwise adjust slide formatting at the time that shows are imported in step 315.

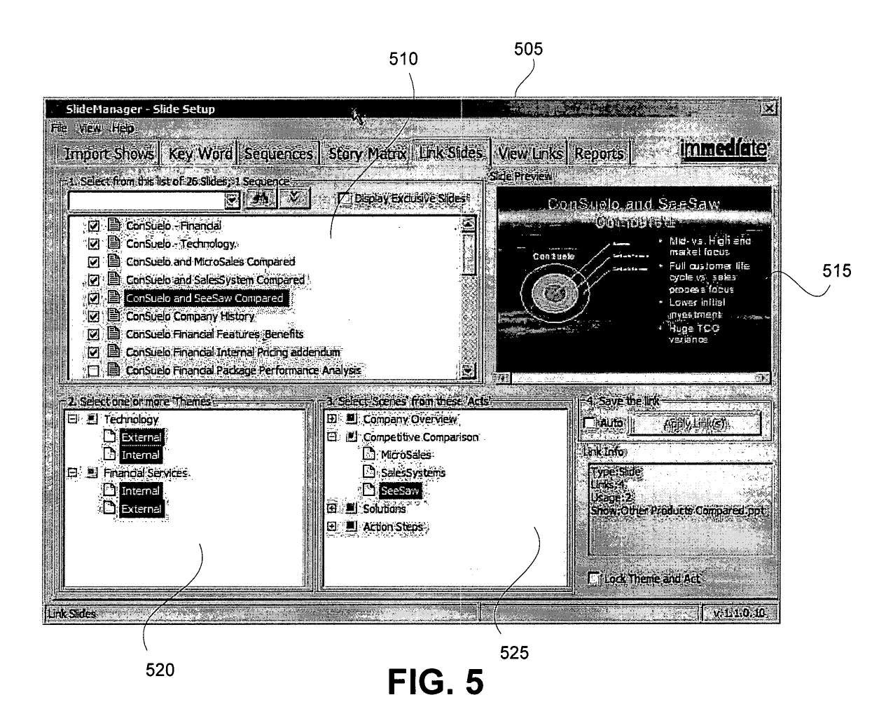

FIG. 5 is an illustration of a graphical user interface used in associating one or more story matrix elements with a slide, according to an embodiment of the invention. As shown therein, a GUI 505 includes a slide selection window 510, a slide preview window 515, a theme selection window 520 and a act/scene selection window 525.

In performing step 330, an administrator or other user at the director level 110 may associate one or more slides selected in slide selection window 510 with one or more themes in theme window 520, and an act and a scene in act/scene window 525. In the illustrated example, a slide having the title “ConSuelo and SeeSaw Compared” has been associated with Internal and External “Technology” and “Financial Services” themes, an act called “Competitive Comparison,” and a scene called “SeeSaw.”

Advantageously, the keywords, metadata, sequence information, and/or story matrix elements associated with presentation slides at director level 110 can be exploited when a presentation is built at presentation level 120.

Presentation Level

FIG. 6 is a process flow diagram of a show creation process, according to an embodiment of the invention. FIG. 6 represents an exemplary embodiment of operations at presentation level 120. As shown in FIG. 6, the process begins in step 605 when a content consumer or other user logs into the system. In step 610, a story builder process identifies audience needs or other presentation objectives, for example with reference to themes, acts, and/or scenes. Slide search step 615 aids a user in identifying slides based on keyword or other metadata, and/or based on sequence information. A content consumer may review slides in step 620, format slides in step 625, and output one or more custom slide shows in step 630.

In one embodiment, a user is led through the processes depicted in FIG. 6 by a presentation wizard. In the illustrated embodiment, steps 610 and 615 are used in the alternative. In another embodiment, however, steps 610 and 615 may be used in combination. Moreover, in alternative embodiments, steps 620 and/or 625 are omitted. In addition, embodiments of the invention may use other search tools, such as Microsoft® Office 2003 Research Library Service in the alternative, or in combination, with the process described above with reference to FIG. 6.

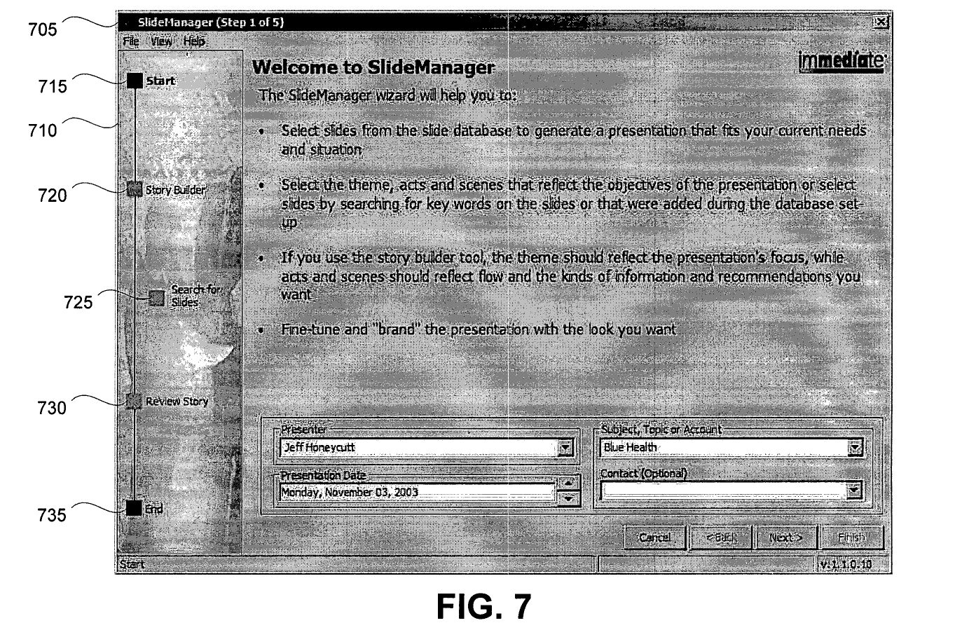

Steps 605, 610, 615, 620, and 625 are described in more detail below with reference to FIGS. 7, 8, 9, 10, and 11, respectively.

FIG. 7 is an illustration of a graphical user interface used in a log-in process, according to an embodiment of the invention. As shown therein, a GUI 705 includes a workflow area 710 having buttons 715, 720, 725, 730, and 735. Buttons 715, 720, 725, 730, and 735 correspond to process steps 605, 610, 615, 620, and 625, respectively.

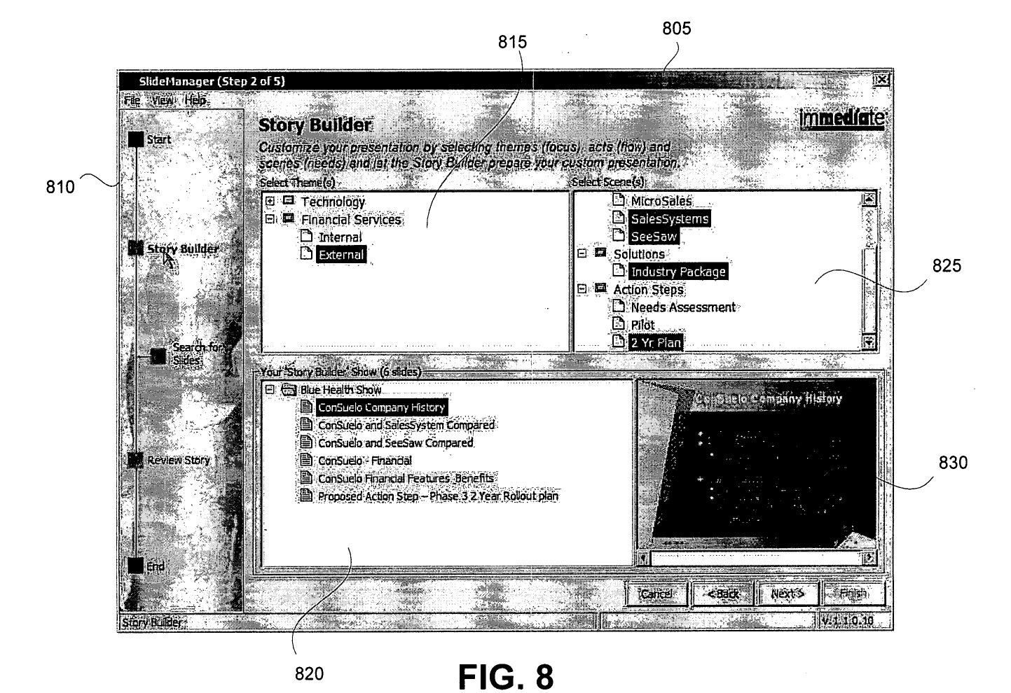

FIG. 8 is an illustration of a graphical user interface used in a story-builder process, according to an embodiment of the invention. As shown therein, a GUI 805 includes a workflow area 810 (similar to workflow area 710), a theme selection window 815, an act/scene selection window 825, a slide show window 820, and a slide preview window 830. In operation, a content consumer or other user at presentation level 120 builds a story by selecting a theme from theme selection window 815. In response, GUI 805 displays act and scene choices that correspond to the selected theme in act/scene selection window 825. A user then selects acts and scenes from act/scene selection window 825. In response, GUI 805 displays slides in slide show window 820 that correspond to the selected scenes. GUI 805 further displays a user-selected slide from slide show window 820 in preview window 830. In an embodiment of the invention, scenes in act/scene selection window 825 are only displayed after a user selects acts in the act/scene selection window 825.

As used herein, themes relate to a topical focus of the slide show being created, acts relate to the flow (or ordering) of information in the slide show being created, and scenes relate to specific needs, requirements, or presentation points for the slide show being created.

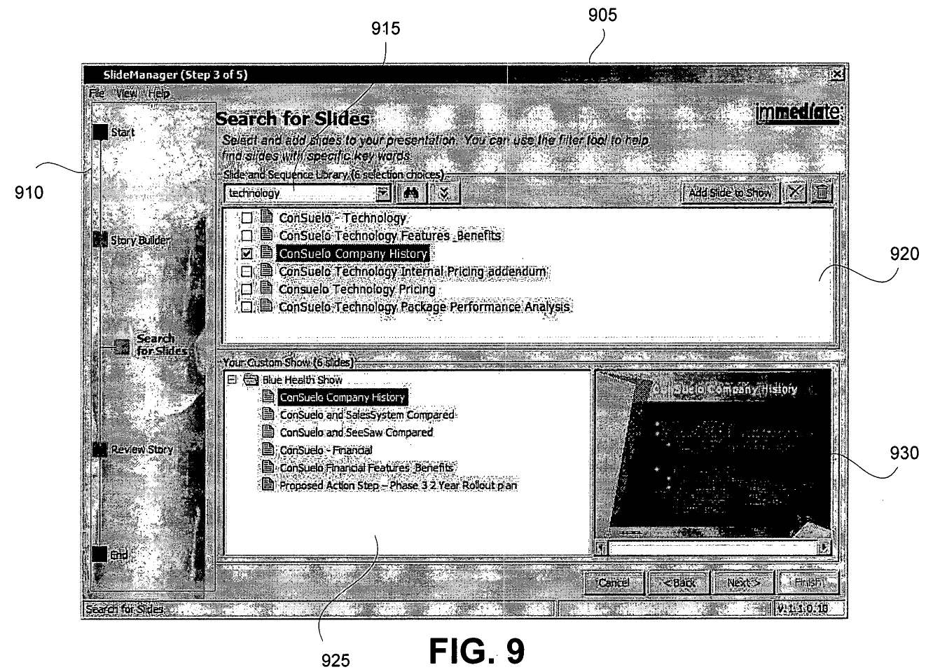

FIG. 9 is an illustration of a graphical user interface used in a searching process, according to an embodiment of the invention. As shown therein, a GUI 905 includes a workflow area 910 (similar to workflow areas 710 an 810), a keyword input area 915, a slide and sequence selection window 920, a slide show window 925, and a preview window 930. In operation, a content consumer or other user at presentation level 120 searches for slides by inputting a keyword in keyword input area 915. In response, GUI 905 displays slides and/or sequences in slide and sequence selection window 920. Where a user selects a slide in slide and sequence selection window 920, GUI 905 lists the selected slide in slide show window 925. Where a user selects a sequence in slide and sequence selection window 920, GUI 905 adds the selected slides or sequence in custom slide show window 925, in the predetermined order. In one embodiment of the invention, a content consumer cannot delete individual slides from the predefined sequence group, nor change the predefined order in the presentation being created.

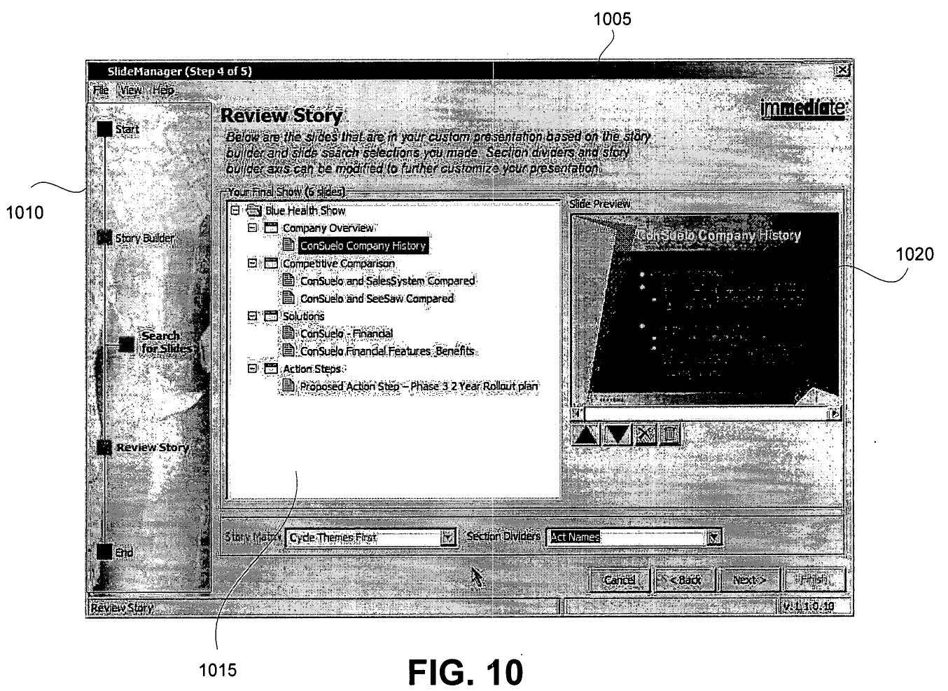

FIG. 10 is an illustration of a graphical user interface used in a reviewing process, according to an embodiment of the invention. As shown therein, a GUI 1005 includes a workflow area 1010 (similar to workflow areas 710, 810, and 910), a slide show window 1015 and a preview window 1020. In operation, a slide selected in slide show window 1015 is displayed in preview window 1020. Accordingly, a content consumer or other user can review the newly created slide show. In the illustrated embodiment, a user may also edit section dividers and/or make other adjustments to the presentation.

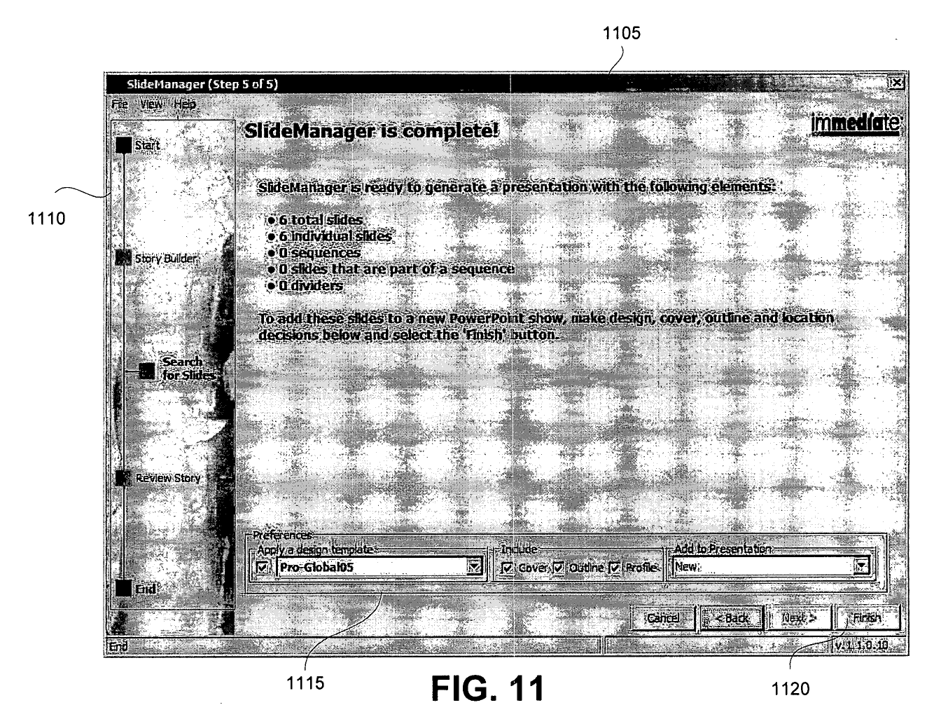

FIG. 11 is an illustration of a graphical user interface used in a formatting process, according to an embodiment of the invention. As shown therein, a GUI 1105 includes a workflow area 1110 (similar to workflow areas 710, 810, 910, and 1010), a design template area 1115, and a finish button 1120. In operation, a content consumer can select a design template in design template area 1115. Clicking finish button 1120 applies the selected design template.

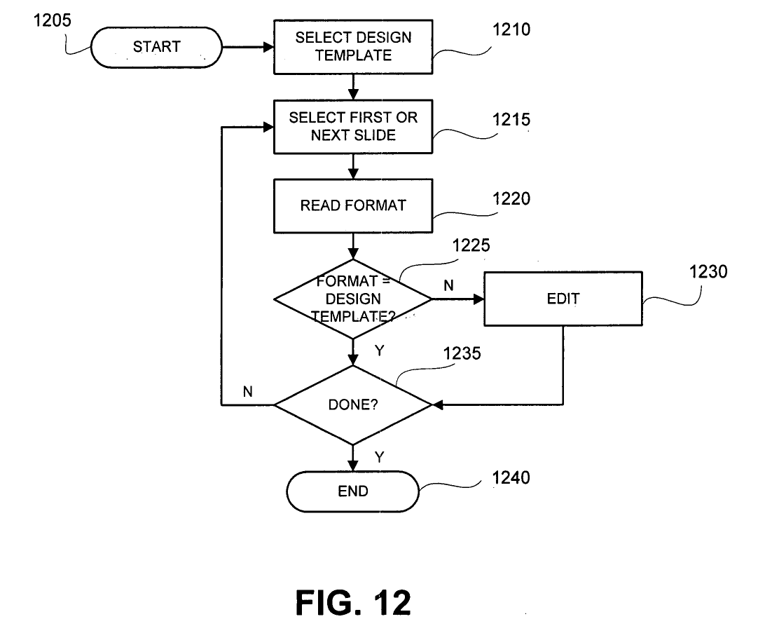

FIG. 12 is a process flow diagram for formatting pages in a document, according to an embodiment of the invention. The process illustrated in FIG. 12 is an exemplary embodiment for the execution of at least a portion of step 625. The operation of step 625 is especially applicable where, for example, slides from several different pre-existing presentations are being used in creating a new presentation, and where the formats of the several pre-existing slides are not uniform.

As shown in FIG. 12, the process starts in step 1205 and advances to select a design template in step 1210. Step 1210 may be executed, for example, by a selection in design template area 1115. Then, in step 1215, the process selects a first or next slide from a new presentation. In step 1220, the first or next slide is read to determine a format. Step 1220 may be executed by exploiting formatting attributes that were associated with the slide in step 315, as described above. The format read in step 1220 may include, for example, background selections, font sizes, font styles, or other formatting information.

Next, in conditional step 1225, it is determined whether the read format is the same as the selected design template in every respect. The operation of condition step 1225 may include, for example, identifying a vertical slide orientation mismatch, identifying a slide color scheme mismatch, identifying a missing title field mismatch, identifying a blank title field, identifying a title font style mismatch, and/or identifying a title font size mismatch.

Where the outcome of conditional step 1225 is in the negative, the process advances to step 1230 to edit the format of the first or next slide before advancing to conditional step 1235. Where the determination of conditional step 1225 is in the affirmative, the process also advances to conditional step 1235 where it is determined whether all of the slides in the presentation have been reviewed. Where the result of conditional step 1235 is in the negative, the process returns to slide selection step 1215. If, however, the output of conditional step 1235 is in the affirmative, the process advances to the end at step 1240.

Preferably, the process illustrated in FIG. 12 operates to automatically identify formatting parameters that are not consistent with the selected design template. Editing step 1230 may be manual (requiring user intervention) or may be automatic.

Detailed Functional Architecture

FIG. 13 is a block diagram of a functional architecture for a content management system, according to an embodiment of the invention. As shown therein, a document management server 1305, other server(s) 1310, and a director/presentation client 1315 are coupled via link 1320.

The architecture in FIG. 13 may be implemented in most any client/server environment. For example, servers 1305 and 1310 may be Web-based servers, and director/presentation client 1315 may be or include, for example, a personal computers or other client terminal having local area network (LAN), wide area network (WAN), or Internet access. An advantage of the client/server environment is scalability from a single client user to thousands of users—the latter case providing significant leverage of knowledge across an organization.

The functional architecture of FIG. 13 enables the execution of application software that performs the steps described above with reference to FIGS. 2-12. In particular, document management server 1305 can implement the processes described with reference to document management level 105 and FIG. 2. The director/presentation client 1315 can implement the processes described with reference to director level 110, presentation level 120, and FIGS. 3-12. Shows could be read from document management server 1305 in step 305, and shows could be read from other server(s) 1310 in step 310. Moreover, the functional architecture illustrated in FIG. 13, and the processes described with reference to FIGS. 2-12 can be implemented in processor-executable code stored on a processor-readable memory.

Alternative architectures also exist. For example, other embodiments do not include document management server 1305, and/or other server(s) 1310. The application of one or more other server(s) 1310 may be advantageous for sharing content across an enterprise. Where director/presentation client 1315 operates alone, it may utilize a local database, without the need to couple to a network-based server.

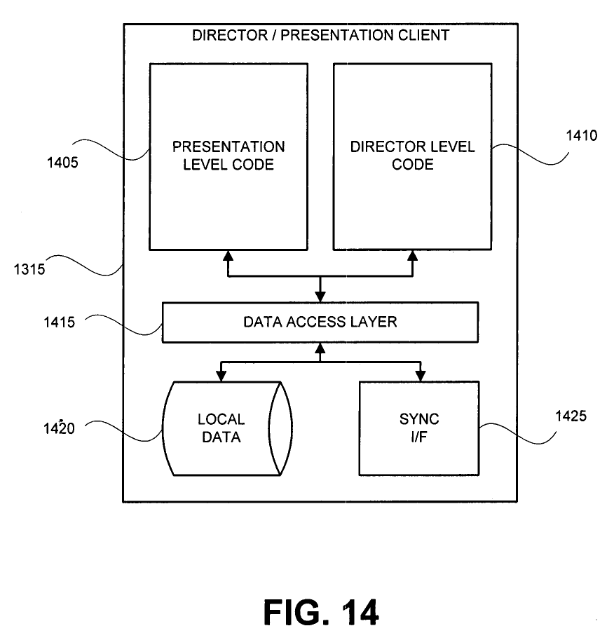

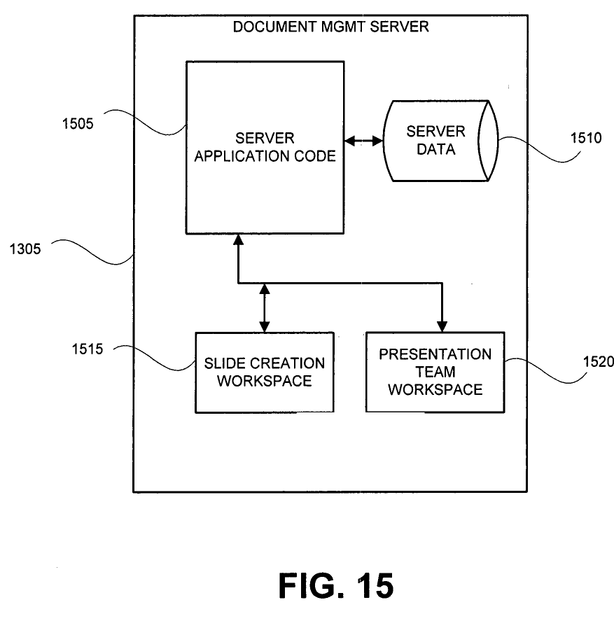

In alternative embodiments, the director/presentation client 1315 may be selectively coupled and decoupled from link 1320. More detailed functional architectures for the director/presentation client 1315 and the document management server 1305 that would support such a synchronization process between the director/presentation client 1315 and the document management server 1305 are described below with reference to FIGS. 14 and 15.

FIG. 14 is a block diagram of a functional architecture for a director/presentation client, according to an embodiment of the invention. As shown therein, a director/presentation client 1315 includes presentation level code 1405 and director level code 1410. Each of presentation level code 1405 and director level code 1410 are coupled through data access layer 1415 to local data 1420 and synchronization interface (sync I/F) 1425.

FIG. 15 is a block diagram of a functional architecture for a document management server, according to an embodiment of the invention. As shown therein, document management server 1305 includes server application code 1505, server data 1510, slide creation workspace 1515, and presentation team workspace 1520. Document management server 1305 may be or include a Microsoft® Windows 2003 Server, and server applications 1505 may be or include SharePoint Portal Server V2.

In an exemplary synchronization process, director/presentation client 1315 may upload a new show via sync I/F 1425 to presentation team workspace 1520 of document management server 1305.

### Conclusion

In conclusion, embodiments of the invention provide, among other things, a system and method for improving the cost and cycle time for developing presentations or other documents. In turn, organizational productivity can also be improved. The systems and methods described herein are applicable to a variety of operations including, but not limited to, advertising/sales, financial and other professional services, business analysis, management, federal, state, and local government, and training functions.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. For example, although the invention has been described with reference to shows that include slides, the invention is more broadly applicable to other collections of media, such as documents having multiple pages, albums of photographs or other graphics, or reports having data tables. In addition, embodiments of the invention could be used to facilitate the creation of mixed media collections. Many variations, modifications and alternative constructions fall within the scope and spirit of the disclosed invention as expressed in the claims.

1. A method for managing information, comprising:
identifying an existing slide show;
selecting a slide of the existing slide show; and
associating metadata with the selected slide.

2. The method of claim 1, further comprising:
identifying the slide based on the metadata; and
creating a new presentation using the identified slide.

3. The method of claim 2, wherein the metadata includes at least one of sequence information and a story matrix element.

4. A method for managing information, comprising:
identifying an existing document;
selecting a portion of the existing document; and
associating metadata with the selected portion of the existing document, wherein the metadata includes sequence information.

5. The method of claim 4, wherein identifying includes searching documents in at least one of a local database and a remote database.

6. The method of claim 4, wherein identifying is based on at least one of creation date and file name.

7. The method of claim 4, wherein selecting a portion of the document includes selecting at least one of a plurality of slides in a slide show.

8. The method of claim 4, wherein associating metadata includes:
associating the selected portion of the document with at least one other selected portion of the document; and
ordering the selected portion with respect to each of the at least one other selected portion.

9. A method for managing information, comprising:
identifying an existing document;
selecting a portion of the existing document;
associating metadata with the selected portion of the existing document, wherein the metadata includes at least one story matrix element.

10. The method of claim 9, wherein associating metadata includes associating at least one of a theme, an act, and a scene with the selected portion.

11. The method of claim 9, wherein associating metadata includes associating each of a theme, an act, and a scene with the selected portion.

12. A machine-readable medium having instructions stored thereon for execution by a processor to perform a method comprising:
identifying an existing slide show;
selecting a slide of the existing slide show; and
associating metadata with the selected slide.

13. The machine-readable medium of claim 12, wherein associating metadata includes associating sequence information with the selected slide.

14. The machine-readable medium of claim 13, wherein associating sequence information with the selected slide includes:
associating the selected slide with at least one other selected slide; and
ordering the selected slide with respect to each of the at least one other selected slide.

15. The machine-readable medium of claim 12, wherein associating metadata includes associating at least one story matrix element with the selected slide.

16. The machine-readable medium of claim 15, wherein associating at least one story matrix element includes associating at least one of a theme, an act, and a scene.

17. A method for creating a slide show, comprising:
inputting a keyword;
receiving a list having at least one of a slide and a sequence of slides, the sequence of slides being defined by a group of individual slides, each of the individual slides having an order with respect to each of the other individual slides in the group; and
selecting at least one of a slide and a sequence of slides from the list.

18. The method of claim 17, further comprising formatting the plurality of pre-existing slides, formatting including:
selecting a design template;
selecting a slide from a slide show;
determining whether the selected slide is formatted in accordance with the selected design template; and
editing a format of the selected slide where it is determined that the selected slide is not formatted in accordance with the selected design template.

19. The method of claim 18, wherein determining includes at least one of identifying a vertical slide orientation mismatch, identifying a slide color scheme mismatch, identifying a missing title field mismatch, identifying a blank title field, identifying a title font style mismatch, and identifying a title font size mismatch.

20. A machine-readable medium having instructions stored thereon for execution by a processor to perform a method comprising:
inputting a keyword;
receiving a list having at least one of a slide and a sequence of slides, the sequence of slide being defined by a group of individual slides, each of the individual slides having an order with respect to each of the other individual slides; and
selecting at least one of a slide and a sequence of slides from the list.

21. A method for creating a slide show, comprising selecting a plurality of pre-existing slides based on at least one of a theme, an act, and a scene.

22. The method of claim 21, wherein selecting a plurality of pre-existing slides includes:
displaying a list of a plurality of themes; and
receiving a theme selection from a user, the theme selection identifying at least one of the plurality of themes.

23. The method of claim 22, wherein selecting a plurality of pre-existing slides further includes:
displaying a list of a plurality of acts; and
receiving an act selection from a user, the act selection identifying at least one of the plurality of acts.

24. The method of claim 23, wherein selecting a plurality of pre-existing slides further includes:
displaying a list of a plurality of scenes; and
receiving a scene selection from a user, the scene selection identifying at least one of the plurality of scenes.

25. The method of claim 24, further comprising displaying slide information, the slide information associated with the scene selection.

26. A machine-readable medium having instructions stored thereon for execution by a processor to perform a method comprising:
displaying a list of a plurality of themes;
receiving a theme selection from a user, the theme selection identifying at least one of the plurality of themes;
displaying a list of a plurality of acts;
receiving an act selection from a user, the act selection identifying at least one of the plurality of acts;
displaying a list of a plurality of scenes; and
receiving a scene selection from a user, the scene selection identifying at least one of the plurality of scenes.

27. A system configured to manage information, the system comprising a workstation, the workstation including:
a data access component;
a director component coupled to the data access component;
a presentation component coupled to the data access component; and
a local database coupled to the data access component, the director component configured to associate metadata with each of a plurality of pre-existing slides, the presentation component configured to create a new presentation based on the metadata.

28. The system of claim 27, further comprising:
a data link selectively coupled to the workstation; and
a server coupled to the data link, the server configured to perform at least one of a storage function and a collaboration function.

29. The system of claim 28, the workstation further including a synchronization component coupled to the data access component, the synchronization component facilitating data transfer from the workstation to the server when the workstation is coupled to the data link.
